(19) United States
(12) Patent Application Publication
(10) Pub. No.: US 2010/0009736 A1
(43) Pub. Date: Jan. 14, 2010

(54) Word Game

(76) Inventor: Michael Dwyer, Franklin, WI (US)

Correspondence Address: MURPHY DESMOND S.C., P.O. BOX 2038, MADISON, WI, 53701-2038, US

(21) Appl. No.: 12/170,726

(22) Filed: Jul. 10, 2008

(51) Int. Cl. A63F 13/00

(52) U.S. Cl. 463/9

(57) ABSTRACT

A word game and method of playing the word game comprising providing a main word or phrase (“Theme Word”), and a group of existing words (“Puzzle Words”), wherein each letter from the Theme Word is used once to form a different word (“Solved Word”) when added to a Puzzle Word. In an embodiment, multiple letters from the Theme Word may be added to a single Puzzle Word to form a single Solved Word. The letters from the Theme Word may be added anywhere to the Puzzle Word in order to form a new Solved Word. In an embodiment, the order of the letters in Puzzle Word may not be changed. In another embodiment the letter from the Theme Word may not be added to the end of the Puzzle Word. The game will be considered solved when all of the letters of the Theme Word have been successfully combined once with a Puzzle Word such that each letter has been used with a Puzzle Word to form a Solved Word.

### BACKGROUND OF THE INVENTION

The invention relates generally to a word game, and in particular, to a “word-creating” game.

Numerous word games are known as shown in patents issued in U.S. Pat. No. 6,623,009 to Kraemer et al. on 23 Sep. 2003; U.S. Pat. No. 6,279,911 to Cherry on 28 Aug. 2001; U.S. Pat. No. 5,799,239 to LeBriton et al. on 04 Aug. 1998; and U.S. Pat. No. 5,586,765 to Lackey on 24 Dec. 1996. Some of these games require the player to unscramble letters to form words. Others require the player to formulate words that begins with or contains certain letters. It is believed that such games may improve the players' vocabulary and spelling. Such benefits may be achieved by other types of word-creating games.

### BRIEF SUMMARY OF THE INVENTION

The objective of the game is to take every letter that makes up the spelling of a main word or phrase (“Theme Word”) and add them to a group of existing words (“Puzzle Words”) in order to form a group of different words (“Solved Words”), wherein each letter in the Theme Word may only be used once per puzzle.

### BRIEF DESCRIPTION OF THE DRAWINGS

FIG. 1 illustrates an embodiment of the invention.

### DETAILED DESCRIPTION OF THE INVENTION

In general, the invention features a method of playing a word game that may be played individually or as a group. A main word or phrase, Theme Word, is provided as the focus of each individual game along with a group of Puzzle Words. The Puzzle Words may or may not be related to the Theme word. Each letter from the Theme Word is used once in combination with a Puzzle Word to form a different word called the Solved Word. Herein, each combination of Theme Word and Puzzle Word is a puzzle, where a game can consist of or comprise one or more puzzles.

The rules for solving the puzzle are as follows. Each letter in the Theme Word must be used only once as it is added to one of the Puzzle Words to form a Solved Word. Ultimately, the game is solved when each letter in the Theme Word has been added once to one of the Puzzle Words to form, singly or in combination with another letter, one of the Solved Words.

The games are created with varying degrees of difficulty. Easier games may consist of a grouping of Puzzle Words that are more obvious to solve than other, less obvious, groupings of Puzzle Words. The easier games allow the player to quickly recognize an obvious choice for a letter to be added in order to form a Solved Word. Also, easier games may have only one letter from the Theme Word added to each Puzzle Word to form the Solved Word. Easier games allow younger children or others with lower cognitive functions to play these games both for fun and for improving their word recognition, vocabulary, and deductive problem solving skills.

A puzzle may be made more difficult by making the conversion from Puzzle Word to Solved Word more difficult to determine. Other ways of making the game more challenging include having Puzzle Words that require several letters to form Solved Words or allowing or requiring the order of the letters of the Puzzle Words to be rearranged in addition to having to add the letter or letters from the Theme Word. Contributing to the difficulty of the game, the game can be played by multiple players as contests where the winner is the first person or team to solve the game or with the shortest time to solution.

In one embodiment, the game is a single puzzle with one Theme Word that can be used to form a group of Solved Words from a group of Puzzle Words printed on a sheet of paper, such as that of a newspaper or magazine. In another embodiment of the game, multiple puzzles are printed in, for example, a book. In a further embodiment, the game is a group of puzzles that is part of a board game where players who can more quickly solve the puzzles can race to a pre-determined goal by moving or accumulating game pieces. The game can also be provided in an electronic format where the puzzle is downloaded from an electronic memory to be displayed on an output device such as, but not limited to, a monitor or a television, and the player can use input devices such as, but not limited to, a mouse or keyboard to select letters to enter into Puzzle Words to form Solved Words. Such games may be made available through a local or wide area network, or through the internet, where players can collaborate or compete in solving the puzzles.

As an example, one way for a game to become more difficult is the ability of a single letter in the Theme Word to be added to several different Puzzle Words. Using the Puzzle Word “BET” and the letters “A” and “S” from the Theme Word “SAMPSON”, the Solved Word could either be “BEAT” or “BEST”. To find the right Solved Word for “BET”, a player may have to find a solution that also solves another Puzzle Word such as “PAT” that can only use one of the letters “A” or “S”. In this case, adding “A” to “PAT” cannot create a new word, but adding “S” to “PAT” can create the new word “PAST.” By deductive reasoning, the appropriate letter to add to “BET” has to be “A” to form the word “BEAT”.

In the foregoing example, if multiple letters can be used, the Solved Word could also be “BEAST”. To make the puzzle even more difficult for the foregoing example, the Solved Word may be based upon adding one or more letters to a re-arrangement of the Puzzle Word letters to form the word “BASTE”.

The degree of difficulty and complexity in the game is increased as more letters in the Theme Word can be added to several Puzzle Words. The game may consist of a number of deductive reasoning solutions of letters that could then make the game more challenging for the player. The more Puzzle Words that allow interchangeable letters to form Solved Words, the more difficult the game may be to solve. Further, difficulty can be increased by having some Puzzle Words will not have a letter or letters added so that there are more Puzzle Words than required to use up the letters of the Theme Word. Furthermore, additional limitations such as prohibiting the addition of a letter to the end of a Puzzle Word or requiring the use of the letter in between letters of the Puzzle Word may also increase the difficulty of the game.

These added layers of difficulty may, of course, be combined to produce even more difficult games. The more difficult games allow a player to progress from easy to difficult as they get better at the skills needed to solve the game. This would allow the games to be put together into a game of progression where the player starts at an easy level and progresses through incrementally higher degrees of difficulty. The player then can gauge his gained skills, if any, by attempting and completing more games and getting further into the progression of difficulty.

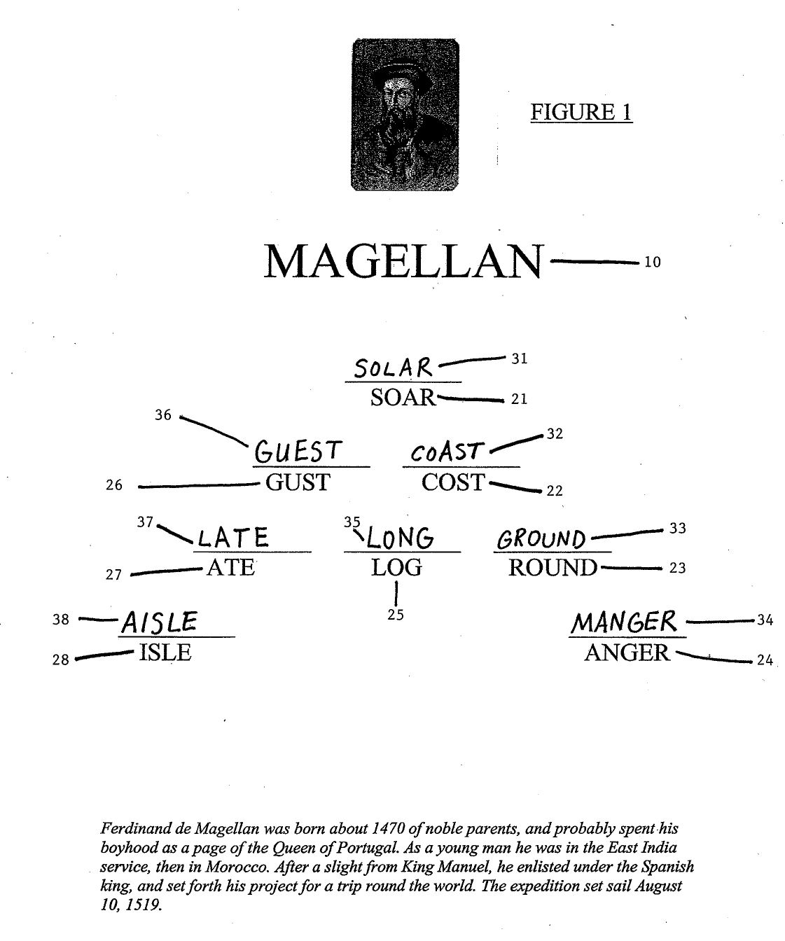

FIG. 1 illustrates an embodiment of the present invention where the Theme Word 10 is “MAGELLAN” and the Puzzle Words, 21-28 are “SOAR”, “COST”, “ROUND”, “ANGER”, “LOG”, “GUST”, “ATE”, and “ISLE”, respectively. By adding the letter “L” from “Magellan” to “SOAR” the player arrives at Solved Word 31 “SOLAR.” The other Solved Words 32-38 are “COAST”, “GROUND”, “MANGER”, “LONG”, “GUEST”, “LATE”, and “AISLE”, respectively. In this illustration “ATE” could potentially form the Solved Word “GATE”. However, the letter “L” cannot be used with “ROUND” to form a Solved Word, so “GATE” cannot be an appropriate solution given the Theme Word and Puzzle Words provided in the puzzle.

Finally, all references, including any priority document, cited herein are hereby incorporated by reference. While the present invention has been described in considerable detail, it will be obvious to those skilled in the art that alterations may be made in the game itself or in the method for playing the game without departing from the concept and scope of the present invention as described in the following claims.

I claim:

1. A method of playing a game comprising:
a) providing a Theme Word;
b) providing a Puzzle Word; and
c) combining a letter in the Theme Word with the Puzzle Word to create a new Solved Word.

2. The method of claim 1 wherein a number of Puzzle Words corresponding to the number of letters in the Theme Word is provided and each letter of the Theme Word is used only once in one of the Puzzle Words until all of the Puzzle Words are combined with a letter to form a Solved Word.

3. The method of claim 1 wherein the Theme Word is a combination of words that form a phrase.

4. The method of claim 1 wherein a number of Puzzle Words greater than the number of letters in the Theme Word is provided and each letter of the Theme Word is used only once in one of the Puzzle Words until all of the letters of the Theme Word have been combined with a Puzzle Word to form a Solved Word, and at least one Puzzle Word has not been changed to a Solved Word.

5. The method of claim 1 wherein a number of Puzzle Words less than the number of letters in the Theme Word is provided and each letter of the Theme Word is used only once in one of the Puzzle Words until all of the letters of the Theme Word have been combined with a Puzzle Word, and at least one Puzzle Word requires the use of more than one letter to form a Solved Word.

6. The method of claim 1 wherein the Theme Word and the Puzzle Word are shown on an electronic display and a player uses an electronic input device to select a letter from the Theme Word in order to combine the letter with the Puzzle Word to form a Solved Word.

7. The method of claim 1 wherein the Theme Word and the Puzzle Word are transmitted through the internet and shown on an electronic display and a player uses an electronic input device to transmit instructions through the internet to select a letter from the Theme Word in order to combine the letter with the Puzzle Word to form a Solved Word.

8. The method of claim 1 wherein the letter cannot be used at the end of the Puzzle Word.

9. The method of claim 1, further comprising moving a game piece when each letter of the Theme Word has been used to form a Solved Word.

10. The method of claim 1, further comprising accumulating an award when each letter of the Theme Word has been used to form a Solved Word.

11. A word game comprising a puzzle having:
a) a Theme Word having a first number of letters;
b) a second number of Puzzle Words; and
c) a rule that require the single use of each of the letters to combine with at least one Puzzle Word to form a Solved Word.

12. The game of claim 11 wherein the first number of letters is the same as the second number of Puzzle Words such that one letter is used in one Puzzle Word.

13. The game of claim 11 wherein the first number of letters is the less than the second number of Puzzle Words such that after each letter is used, at least one Puzzle Word is not used to form a Solved Word.

14. The game of claim 11 wherein the first number of letters is greater than the second number of Puzzle Words such that at least one Puzzle Word will require the use of more than one letter to form a Solved Word.

15. The game of claim 11 wherein the game is stored on an electronic medium and shown on an electronic display, wherein a player uses an electronic input device to select and combine the letter with the Puzzle Word to form the Solved Word.

16. The game of claim 15 wherein the game is transmitted through a media selected from the group consisting of a local area network, a wide area network and the internet to the electronic display.

17. The game of claim 11, comprising multiple puzzles, further comprising a board representing a predetermined goal, and a game piece which may be moved or accumulated in accordance with the speed with which each puzzle is solved.

18. The game of claim 11 further comprising the rule that a letter may not be used at the end of a Puzzle Word.

19. The game of claim 11 further comprising the rule that the Puzzle Word may be rearranged in order to form the Solved Word.

20. The game of claim 11 further comprising the rule that a letter may not be used at either end of a Puzzle Word.
